(19) United States
(12) Patent Application Publication
(10) Pub. No.: US 2011/0007754 A1
(43) Pub. Date: Jan. 13, 2011

(54) Flexible Hardware Checksum Generator

(76) Inventors: Gerald Pepper, Thousand Oaks, CA (US); Robert Luking, Ellicott City, MD (US); Xuegen Zhu, Rowland Heights, CA (US)

Correspondence Address: SoCAL IP LAW GROUP LLP, 310 N. WESTLAKE BLVD. STE 120, WESTLAKE VILLAGE, CA, 91362, US

(21) Appl. No.: 12/501,340

(22) Filed: Jul. 10, 2009

(51) Int. Cl. H04J 3/24

(52) U.S. Cl. 370/474

(57) ABSTRACT

A traffic generator may include a scheduler to provide packet forming data defining a packet; a background engine to retrieve a packet template, the packet template including a first checksum mask, a first pre-sum, and a first address; a fill engine to generate content for variable-content fields of the packet for a payload portion of the packet in accordance with the packet forming data and the packet template; and a checksum engine. The checksum engine may include an accumulator that calculates a payload checksum for the payload portion of the packet and first logic circuits that compute a first checksum based on the first pre-sum, the first mask, and at least some of the payload checksum and the variable-content fields. Insertion logic may insert the first checksum into the packet at a position indicated by the first address.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to generating traffic for testing a network or network device.

2. Description of the Related Art

In many types of communications networks, each message to be sent is divided into portions of fixed or variable length. Each portion may be referred to as a packet, a frame, a cell, a datagram, a data unit, or other unit of information, all of which are referred to herein as packets.

Each packet contains a portion of an original message, commonly called the payload of the packet. The payload of a packet may contain data, or may contain voice or video information, or a combination thereof. The payload of a packet may also contain network management and control information. In addition, each packet contains identification and routing information, commonly called a packet header. The packets are sent individually over the network through multiple switches or nodes. The packets are reassembled into the message at a final destination using the information contained in the packet headers, before the message is delivered to a target device or end user. At the receiving end, the reassembled message is passed to the end user in a format compatible with the user's equipment.

Communications networks that transmit messages as packets are called packet switched networks. In order to test a packet switched network or a device included in a communications network, it is often desirable to generate network traffic having a data rate equal to the line rate or maximum possible data rate of the network communication path or device.

A series of packets originating from a single source and having a specific type of packet and a specific rate will be referred to herein as a “stream.” A source may be, for example, a port on a network interface. A source may support multiple outgoing streams simultaneously and concurrently, for example to accommodate multiple packet types or rates. “Simultaneously” means “at exactly the same time.” “Concurrently” means “within the same time.”

For the purpose of reporting network traffic data, the packets within a stream may be organized into flows, where a “flow” is any plurality of data units for which network traffic statistics are accumulated and reported. The data units in a given flow may be distinguished by a flow identifier contained in each data unit. The flow identifier may be, for example, an address, a port number, a tag, or some other field or combination of fields within each data unit.

A plurality of concurrent streams may be combined to form the output from a traffic generator, which will be referred to herein as “test traffic”. The streams within the test traffic may be combined through interleaving. The interleaving may be balanced, unbalanced, and distributed among the represented streams. The data rate of the test traffic may be equal to the line rate of a network communication path over which the output is transmitted. Although the packets within a given stream may be transmitted at the line rate, the average data rate of each stream over time may be much lower, since a plurality of interleaved streams may share the data rate of the test traffic. To test a modern “triple play” network and network equipment, the test traffic may contain simulated data, audio, and video streams.

The header of a packet may typically include a checksum that may be used, upon reception of the packet, to confirm that the packet was transmitted and received correctly. A checksum is typically calculated by segmenting a predetermined portion of the packet content into 16-bit segments and then calculating the 1's complement sum of all of the segments. The portion of the packet over which a checksum is calculated will be referred to herein as the “scope” of the checksum. The 1's complement of the sum is then inserted into the packet as the checksum. Upon reception, the packet can be validated by calculating the 1's complement sum of the predetermined portion of the packet including the checksum. If the packet has been received correctly, the sum will be all 1's .

Packet switched networks commonly use nested communications protocols such that a packet may start with a header for a low-level protocol which is followed by headers for one or more higher level protocols. For example, packets transmitted within an Ethernet network commonly start with an Ethernet header or media access (MAC) header, followed by an Internet protocol (IP) header, followed by a Transmission Control Protocol (TCP) header. Both the IP header and the TCP header include checksums which have different scope. The IP checksum is calculated over the IP header only. The TCP checksum is calculated over portions of the IP header, the TCP header, and the payload of the packet.

### DESCRIPTION OF THE DRAWINGS

FIG. 1 is a block diagram of a network environment.

FIG. 2 is a block diagram of a traffic generator.

FIG. 3 is a block diagram of transmit engine.

FIG. 4A is a diagram of the content of an exemplary TCP/IP packet.

FIG. 4B is a diagram of the content of an exemplary UDP/IP packet.

FIG. 4C is a diagram of the content of an exemplary TCP/IP packet transmitted using a tunneling protocol.

FIG. 5 is diagram illustrating the formation of a packet.

FIG. 6A is a table containing exemplary checksum masks

FIG. 6B is a table containing exemplary checksum masks.

FIG. 7 is block diagram of a checksum engine.

FIG. 8 is block diagram of a checksum calculator.

FIG. 9 is block diagram of a checksum calculator.

FIG. 10 is a flow diagram of a process for generating traffic.

Throughout this description, elements appearing in block diagrams are assigned three-digit reference designators, where the most significant digit is the figure number and the two least significant digits are specific to the element. An element that is not described in conjunction with a block diagram may be presumed to have the same characteristics and function as a previously-described element having a reference designator with the same least significant digits.

In block diagrams, arrow-terminated lines may indicate data paths rather than signals. Each data path may be multiple bits in width. For example, each data path may consist of 16, 32, 64, 128, 256, or more parallel connections.

### DETAILED DESCRIPTION

Description of Apparatus

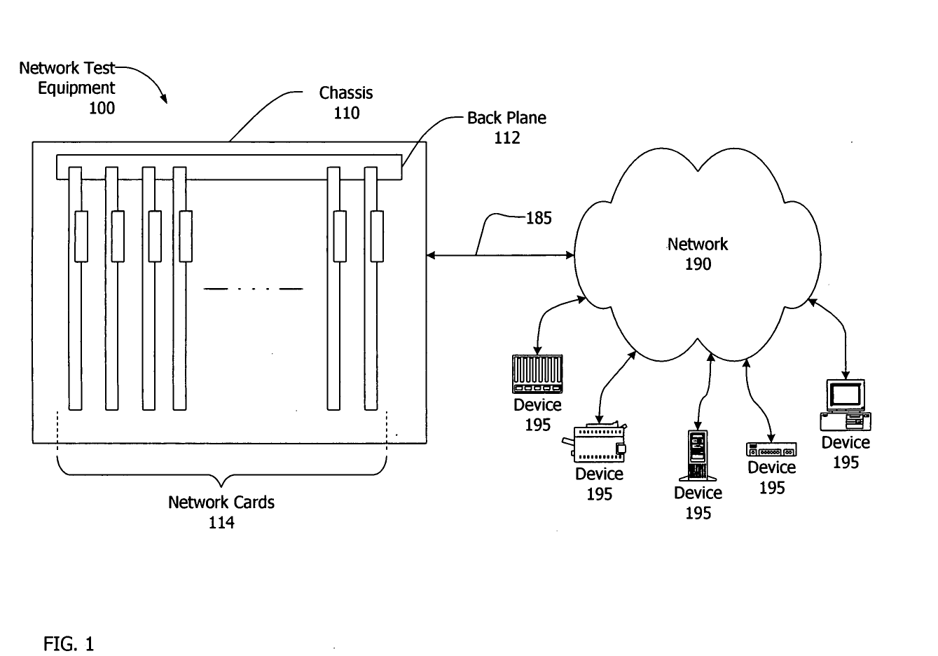

Referring now to FIG. 1, there is shown a block diagram of a network environment. The environment may include network test equipment 100, a network 190 and plural network devices 195.

The network test equipment 100 may be a network testing device, performance analyzer, conformance validation system, network analyzer, or network management system. The network test equipment 100 may include one or more network cards 114 and a back plane 112 contained or enclosed within a chassis 110. The chassis 110 may be a fixed or portable chassis, cabinet, or enclosure suitable to contain the network test equipment. The network test equipment 100 may be an integrated unit, as shown in FIG. 1. Alternatively, the network test equipment 100 may comprise a number of separate units cooperative to provide traffic generation and/or analysis. The network test equipment 100 and the network cards 114 may support one or more well known standards or protocols such as the various Ethernet and Fibre Channel standards, and may support proprietary protocols as well.

The network cards 114 may include one or more field programmable gate arrays (FPGAs), application specific integrated circuits (ASICs), programmable logic devices (PLDs), programmable logic arrays (PLAs), processors and other kinds of devices. In addition, the network cards 114 may include software and/or firmware. The term network card encompasses line cards, test cards, analysis cards, network line cards, load modules, interface cards, network interface cards, data interface cards, packet engine cards, service cards, smart cards, switch cards, relay access cards, and the like. The term network card also encompasses modules, units, and assemblies that may include multiple printed circuit boards. Each network card 114 may provide one or more network ports. The ports of the network cards 114 may be connected to the network through a communication medium 185, which may be a wire, an optical fiber, a wireless link, or other communication medium. Each network card 114 may support a single communications protocol, may support a number of related protocols, or may support a number of unrelated protocols. The network cards 114 may be permanently installed in the network test equipment 100 or may be removable.

The back plane 112 may serve as a bus or communications medium for the network cards 114. The back plane 112 may also provide power to the network cards 120.

The network devices 195 may be any devices capable of communicating over the network 190. The network devices 195 may be computing devices such as workstations, personal computers, servers, portable computers, personal digital assistants (PDAs), computing tablets, cellular/mobile telephones, e-mail appliances, and the like; peripheral devices such as printers, scanners, facsimile machines and the like; network capable storage devices including disk drives such as network attached storage (NAS) and storage area network (SAN) devices; networking devices such as routers, relays, hubs, switches, bridges, and multiplexers. In addition, the network devices 195 may include appliances, alarm systems, and any other device or system capable of communicating over a network.

The network 190 may be a Local Area Network (LAN), a Wide Area Network (WAN), a Storage Area Network (SAN), wired, wireless, or a combination of these, and may include or be the Internet. Communications on the network 190 may take various forms, including frames, cells, datagrams, packets or other units of information, all of which are referred to herein as packets. The network test equipment 100 and the network devices 195 may communicate simultaneously with one another, and there may be plural logical communications between the network test equipment 100 and a given network device 195. The network itself may be comprised of numerous nodes providing numerous physical and logical paths for data to travel.

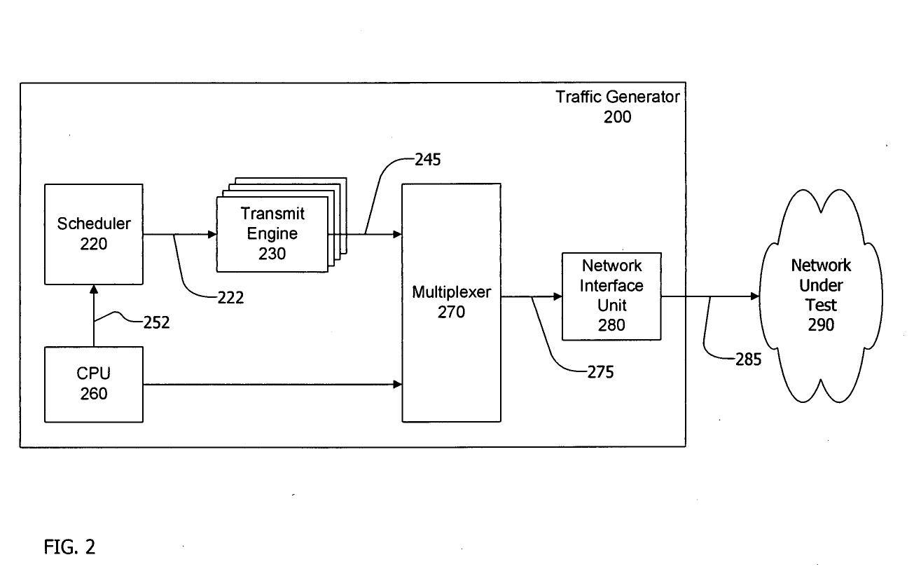

Referring now to FIG. 2, an exemplary traffic generator 200 may include a scheduler 220, at least one transmit engine 230, a network interface unit 280, and a central processing unit (CPU) 260. When the traffic generator 200 includes plural transmit engines 230, a multiplexer 270 may interleave the packets generated by the plural transmit engines 230. While the exemplary traffic generator 200 shown in FIG. 2 includes four transmit engines 230, the traffic generator 200 may have more or fewer transmit engines. The exemplary traffic generator 200 may be all or a portion of a network card 114 as shown in FIG. 1.

Within this description, the term “engine” means a collection of hardware, which may be augmented by firmware and/or software, that performs the described functions. An engine may typically be designed using a hardware description language (HDL) that defines the engine primarily in functional terms. The HDL design may be verified using an HDL simulation tool. The verified HDL design may then be converted into a gate netlist or other physical description of the engine in a process commonly termed “synthesis”. The synthesis may be performed automatically using a synthesis tool. The gate netlist or other physical description may be converted into process instructions and masks for fabricating the engine within an application specific integrated circuit (ASIC). The gate netlist or other physical description may be further converted into programming code for implementing the engine in a programmable device such as a field programmable gate array (FPGA), a programmable logic device (PLD), or a programmable logic array (PLA). The programming code for implementing the engine in a programmable device such as an FPGA may be stored on a compact disc or other machine-readable storage medium.

Within this description, the term “unit” also means a collection of hardware, firmware, and/or software, which may be on a larger scale than an “engine”. For example, a unit may contain multiple engines, some of which may perform similar functions in parallel. The terms “engine” and “unit” do not imply any physical separation or demarcation. All or portions of one or more units and/or engines may be collocated on a common card, such as a network card 114, or within a common FPGA, ASIC, or other circuit device.

The CPU 260 may provide the scheduler 220 with instructions 252 to form a plurality of streams that may be interleaved to form test traffic 275. Each of the streams may include a sequence of packets. The packets within each steam may be of the same general type but may vary in length and content. The scheduler 220 may perform multiple functions including scheduling the sequence of packets to be generated and determining the length and variable content for each packet. In the case where the traffic generator includes plural transmit engines, the scheduler 220 may assign each packet to a selected one of the transmit engines 230.

The scheduler 220 may pass packet forming data 222 required to generate each packet to the selected transmit engine 230. The packet forming data 222 passed from the scheduler 220 to the selected transmit engine 230 may include a stream identifier which identifies the type of packet, a packet length, user defined field (UDF) data to be incorporated into the packet, and instructions for filling the packet payload.

The network interface unit 280 may convert the test traffic 275 from the multiplexer 280 into the electrical, optical, or wireless signal format required to transmit the data flow to the network under test 290 via a link 285. The link 285 may be a wire, an optical fiber, a wireless link, or other communication link.

The CPU 260 may include a processor, a memory coupled to the processor, and various specialized units, circuits, software and interfaces for providing the functionality and features described here. The processes, functionality and features may be embodied in whole or in part in software which operates on the processor and may be in the form of firmware, an application program, an applet (e.g., a Java applet), a browser plug-in, a COM object, a dynamic linked library (DLL), a script, one or more subroutines, or an operating system component or service. The hardware and software and their functions may be distributed such that some functions are performed by the processor and others by other devices, engines, or units on the same or another card.

The scheduler 220, the one or more transmit engines 230, the CPU 260, the multiplexer 270 and the network interface unit 280 may include or be one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The physical partitioning of the components of the traffic generator 200 may be different from the functional partitioning shown in FIG. 2, such that a given functional component or block may be divided between two or more circuit devices and a single circuit device may contain all or portions of two or more functional components or all functional components.

The data flow to the network under test 290 over the link 285 may have a maximum data rate, commonly termed the “line rate”. The data flow over the link 285 may use encoding to facilitate transmission. The encoding may cause the line rate and the actual clock rate for the data to be different. For example, the actual clock rate of a 10 GHz link using 64 bit to 66 bit encoding may be 10.3125 GHz. Although the data rate through the traffic generator may be the same as the line rate, the data paths between the various functional blocks may transmit multiple bits in parallel such that the actual clock rate within the functional blocks may be less than the line rate. For example, a traffic generator with a 10 GHz line rate may process 50 bits in parallel and have an internal clock rate of about 200 MHz.

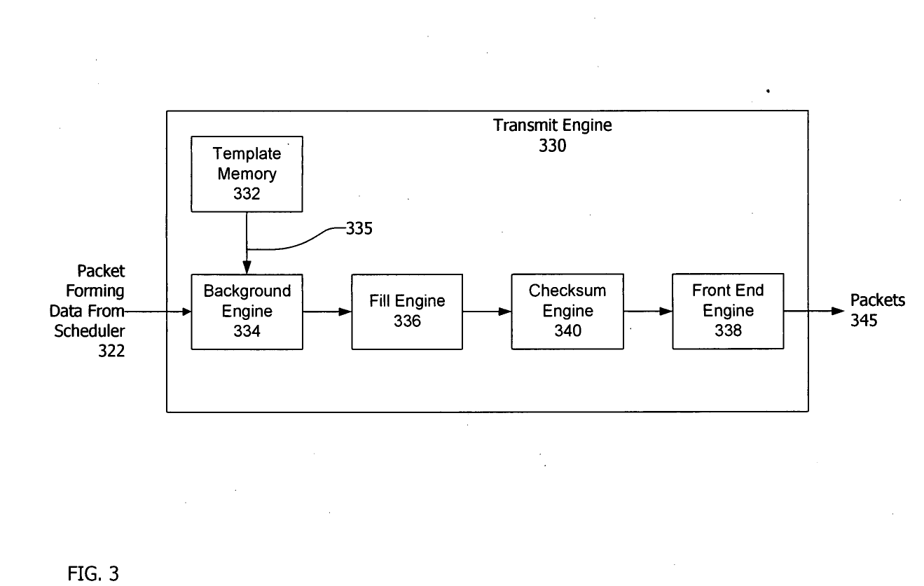

Referring now to FIG. 3, an exemplary transmit engine 330, which may be suitable for use as the transmit engine 230, may include a template memory 332, a background engine 334, a fill engine 336, a checksum engine 340, and a front end engine 338.

The template memory 332 may store packet templates for each of the packet streams and/or packet types that may be formed by the transmit engine 330. Each packet template may define a specific packet structure including the length and content of the packet header, the location and content of any fixed-content data fields, the location and extent of any variable-content fields (VCFs), and the location and scope of checksums or other calculated fields, and other information necessary to form the packet. The VCFs may include one or more UDF, one or more length field, and any other variable-content data fields to be filled by the fill engine 336. The template memory 332 may be a read-only memory that stores a fixed set of packet templates. The template memory 332 may be a writable memory where packet templates may be stored dynamically, or a combination of read-only and writable memories. Packet templates may be created by a processor (not shown in FIG. 3) and stored in a writable template memory 332, for example, at the start of each test session.

The transmit engine 330 may receive packet forming data 322 from a scheduler, such as the scheduler 220. The packet forming data 322 may include a stream ID or other data indicating the type of packet to be formed. Upon receipt of the packet forming data 322, the background engine 334 may retrieve the appropriate packet template 335 from the template memory 332. The background engine 334 may also extend or truncate the packet template 335 to set the packet length as indicated in the packet forming data 322.

After the appropriate packet template 335 has been retrieved, the fill engine 336 may insert UDF data included in the packet forming data 322 into the appropriate positions within the packet as indicated by the packet template. The background engine 334 and/or the fill engine 336 may fill the payload of the packet 345 as instructed in the packet forming data 322.

The checksum engine 340 may compute and insert any required checksums. A packet being formed typically requires one or more checksums. Each checksum may typically be calculated by segmenting a predetermined portion of the packet content into 16-bit segments and then calculating the 1's complement sum of all of the segments. Other methods of checksum calculation may be used. The predetermined portion, or scope, of each checksum may be different. The checksum engine 340 may compute checksums based on the packet template 335, the content of the VCFs, and the content of the payload. For example, the checksum engine 340 may compute an Internet Protocol version 4 (IPv4) header checksum and a Transmission Control Protocol (TCP) header checksum. The header checksums may be calculated and inserted into the packet before the packet 345 is sent to a multiplexer or network interface unit (not shown in FIG. 3), since the header checksums are commonly positioned in the packet before at least a portion of the data being checked.

The front end engine 338 may calculate a cyclic redundancy code (CRC) for the entire packet while the packet 345 is being sent. A CRC basically encodes the entire content of the packet into a unique binary number, typically 32 bits in length. The CRC provides another method, in addition to checksums, to verify that a packet was transmitted and received correctly. The front end engine 338 may insert the CRC at the very end of the packet.

Although FIG. 3 shows, for ease of explanation, the background engine 334, the fill engine 336, the checksum engine 340, and the front end engine 338 as separate and sequential functions, the various engines may share hardware elements and may perform their respective functions at least partially in parallel. For example, the checksum engine 340 may accumulate a checksum for the payload portion of a packet as payload data is formed by the fill engine, as opposed to waiting for the entire payload to be filled.

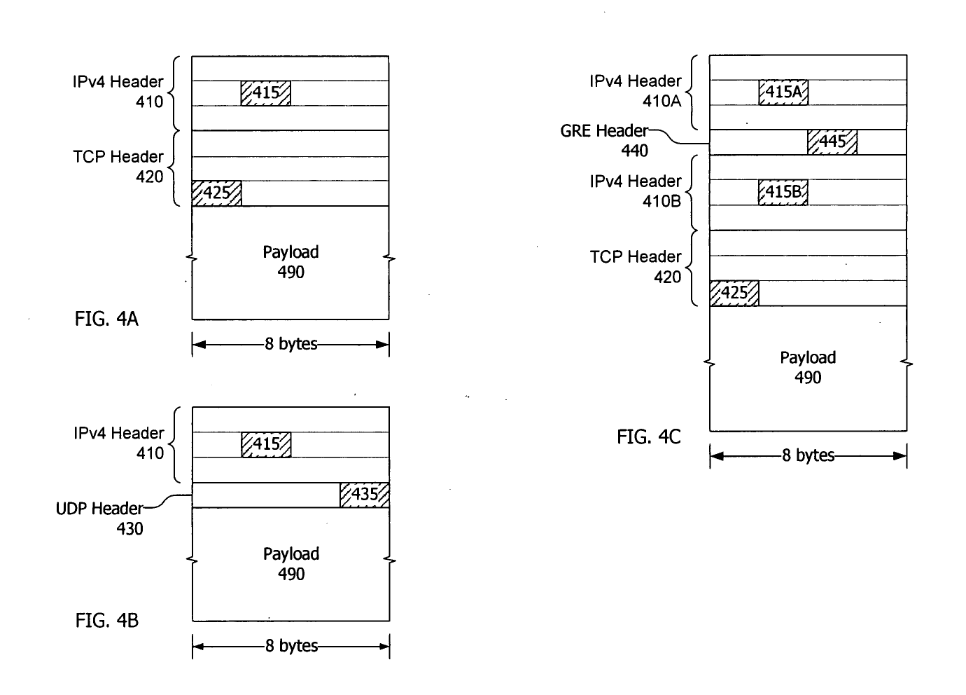

FIG. 4A, FIG. 4B, and FIG. 4C illustrate representative locations of checksums within representative packets. FIG. 4A, FIG. 4B, and FIG. 4C are based on a presumption that a data bus width within a transmit engine is 8 bytes, or 64 bits. The data bus width may be more or fewer than 64 bits.

FIG. 4A represents an IP/TCP packet having an IPv4 header 410 including an IPv4 checksum 415 and a subsequent TCP header 420 including a TCP checksum 425. The scope of the IPv4 checksum 415 is the entire IP header 410 only. The scope of the TCP checksum 425 includes a portion of the IPv4 header 410, the entire TCP header 420 and the entire payload 490. The position and scope of the checksums 415 and 425 are defined by industry standards for the IPv4 and TCP communications protocols, respectively.

FIG. 4B represents an IP/UDP packet having an IPv4 header 410 including an IPv4 checksum 415 and a subsequent User Datagram Protocol (UDP) header 430 including a UDP checksum 435. The scope of the IPv4 checksum 415 is the entire IPv4 header 410 only. The scope of the UDP checksum 435 is a portion of the IPv4 header 410, the entire UDP header 430 and the entire payload 490. The position and scope of the checksums 415 and 435 are defined by industry standards for the IPv4 and UDP communications protocols, respectively.

FIG. 4C represents an IP/TCP packet transmitted using a tunneling protocol. The packet starts with a first IPv4 header 410A including a first IPv4 checksum 415A, followed by a Generic Routing Encapsulation (GRE) header 440 including an optional GRE checksum 445. The scope of the first IPv4 checksum 415A is the entire first IPv4 header 410A only. The scope of the GRE checksum 445 is the entire GRE header 440 and all subsequent portions of the packet. The GRE header 440 is followed by a second IPv4 header 410B including a second IPv4 checksum 415B, a TCP header 420 which includes a TCP checksum 425, and the payload 490. The scope of the second IPv4 checksum 415B is the entire second IPv4 header 410B only. The scope of the TCP checksum 425 is a portion of the second IPv4 header 410B, the entire TCP header 420 and the entire payload 490. The position and scope of the checksums 415A and 415B are defined by industry standards for the IPv4 communications protocol. The position and scope of the checksums 445 and 425 are defined by industry standards for the GRE and TCP communications protocols, respectively.

The examples of FIG. 4A, FIG. 4B, and FIG. 4C demonstrate that the number, location, and scope of checksums varies between different types of packets. FIG. 4A, FIG. 4B, and FIG. 4C illustrate three common packet formats. Packet streams conforming to these and numerous other current and future protocols and combinations of protocols may be needed to test a network.

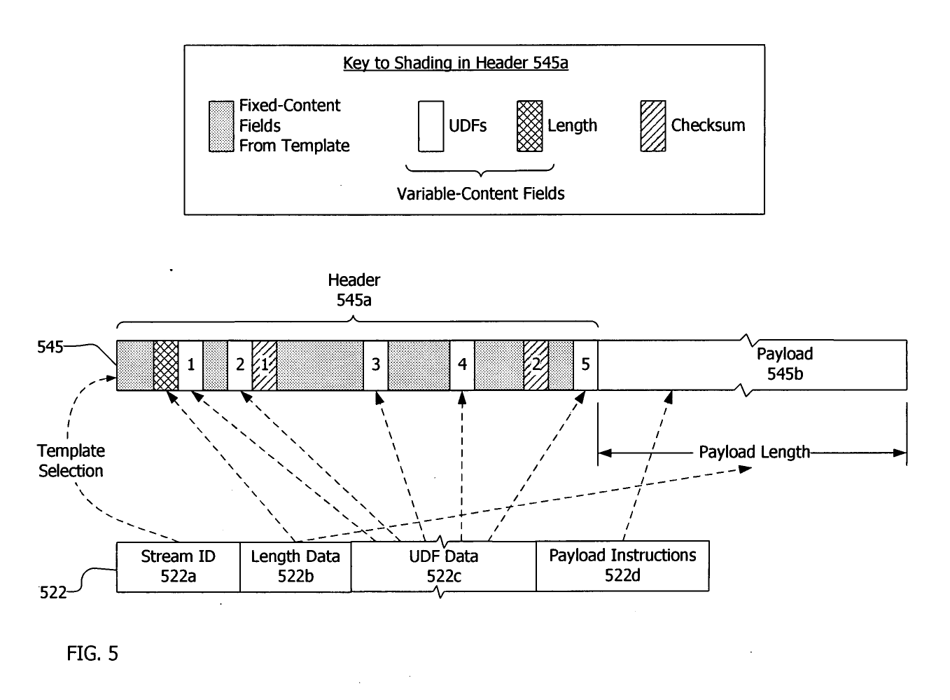

FIG. 5 graphically depicts the actions taken by a transmit engine, such as the transmit engine 330, to form an exemplary packet 545 from representative packet forming data 522. The packet forming data 522 may include a stream ID 522a which may be used by the transmit engine to select a packet template associated with the identified stream. The packet template may define a common structure for each packet in the stream. The packet template may define some fields within each packet as fixed-content fields and may provide the content for those fields. The packet template may define other portions of each packet as VCFs to be generated by the transmit engine as the packet is formed. The packet template may include a definition of each VCF. The VCFs may include one or more UDFs and one or more length fields. The packet template may also define the position and scope of one or more checksum fields.

The packet forming data 522 may also include a packet length 522b which may be used by the transmit engine to set the length of the packet 545. Commonly, the length of the packet 345 may be set by adjusting the length of the payload 545b. The packet length 522b may be inserted into a variable-content packet length field defined in the packet template.

The packet forming data 522 may include UDF data 522c which the transmit engine may use to generate UDFs to insert into the packet header 545a and/or payload 545b, as defined by the packet template and indicated by the dashed arrows. The stream ID 522a may also be inserted into a field in the packet.

The packet forming data 522 may also include payload instructions that the transmit engine may use to form content for the packet payload 545b.

The packet header 545a may include fixed-content fields and VCFs as defined in the packet template. Fixed-content fields are shown in FIG. 5 with solid shading. VCFs in the packet header may include a length field, shown in FIG. 5 with cross-hatching, and one or more UDFs, shown in FIG. 5 without shading. Although FIG. 5 shows a packet header 545a that includes five UDFs, numbered 1 to 5, a packet may have more or fewer than five UDFs. The packet header 545a may also contain one or more checksum fields, shown in FIG. 5 with single hatching. FIG. 5 shows an exemplary packet 545 that includes two checksum fields. The packet 545 may include more than two checksum fields to support present or future protocols.

Each checksum field in a packet may be calculated based on a different scope, or different portions of the packet content, as indicated in the packet template. The scope of each checksum may or may not include the payload portion of the packet. The scope of each checksum may include different fields of the header portion of the packet, including fixed-content header fields and/or VCFs. A variable-content header field may not be included in the scope of any checksum or may be included in the scope of one or more checksums.

When the scope of a checksum includes fixed-content header fields, a pre-sum may be calculated based on the fixed-content fields. The pre-sum, essentially a checksum of the fixed-content fields within the scope of the associated checksum, may be pre-calculated and included in the packet template. Since, a packet may contain checksums having different scopes, the packet template may include a respective pre-sum associated with each checksum.

Each packet template may include information indicating the number and location of one or more checksums. Each packet template may also include a mask associated with each checksum. Each mask may define which fields are included in the scope of the corresponding checksum. The masks may be organized, for example, as a table with each mask corresponding to a row of the table.

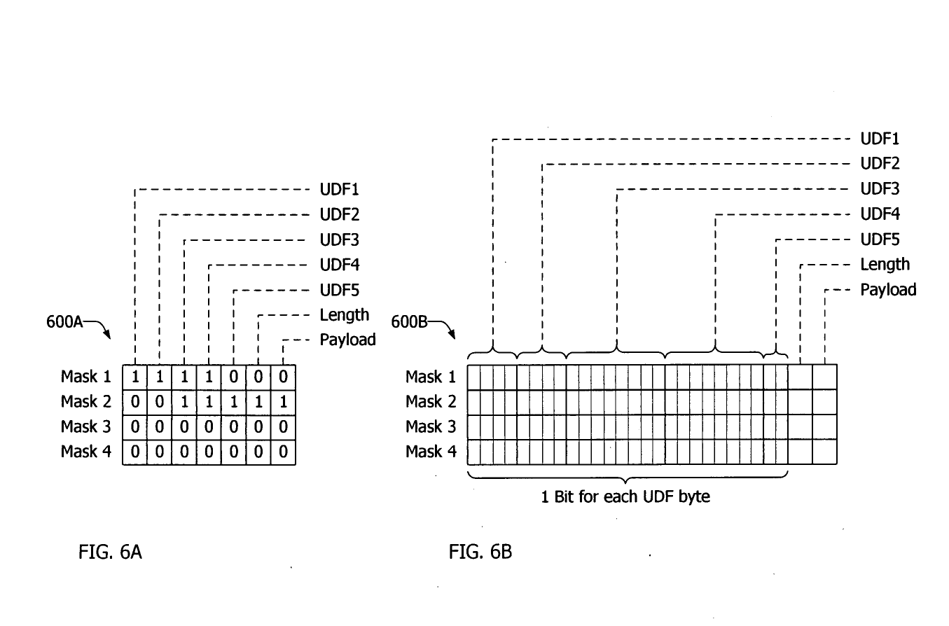

If the locations and lengths of the VCFs are constrained such that each VCF is positioned wholly within, or wholly without, the scope of each checksum, the mask for each checksum may contain a single bit corresponding to each VCF. The value of each bit may indicate if the corresponding VCF is, or is not, within the scope of the checksum. For example, as shown in FIG. 6A, a packet template may include a table 600A including four masks (Mask 1, Mask 2, Mask 3, Mask 4) corresponding to four checksums. Assuming that the packet template defines packets having five UDFs and a length field, each of the four masks may include seven bits—one bit associated with each UDF, one bit associated with the length field, and one bit associated with the payload. The value of each bit (in this example: 1=yes, 0=no) may indicate if the associated field is within the scope of the checksum corresponding to each mask. For example, Mask 1 in FIG. 6A indicates that the Length field, UDF1, UDF 2, and UDF3 are within the scope of checksum 1, while UDF4, UDF5, and the payload portion of the packet are excluded from the scope of checksum 1. Similarly, Mask 2 indicates that UDF2, UDF3, UDF4, and UDF5 fields and the payload are within the scope of checksum 2, while the length field and UDF1 are excluded from the scope of checksum 2.

When the positions and lengths of the VCFs are constrained to lie wholly within, or wholly without, the scope of each checksum, the checksums may be calculated in accordance with the equation:

$${\overline{C S}}_{i} = P {S}_{i} + ( C {S}_{p} ) ( {m}_{i , p} ) + {\sum }_{j = 1}^{n} ( V C {F}_{j} ) ( {m}_{i , j} ) \qquad ( 1 )$$

where: sums are performed using one's complement addition of 16-bit segments;
CSᵢ=checksum i;
PSᵢ=the pre-sum associated with checksum i;
CSₚ=a checksum for the payload portion of the packet;
VCFⱼ=variable-content field j
m_{i,p}=the mask bit indicating if the payload checksum is within the scope of checksum i;
m_{i,j}=the mask bit indicating if variable-content field j is within the scope of checksum i.

In this context “in accordance with” equation (1)” means “in a manner that provides the same result” as equation (1). For example, multiplication of the payload checksum and the variable-content fields by corresponding mask bits may be done by conditional addition rather than by mathematical multiplication. A given field may be added to the checksum IF the corresponding mask bit is true (logical 1), and not added to the checksum IF the corresponding mask bit is false (logical zero).

To provide a user more flexibility in establishing test packet structures, the positions and lengths of the VCFs may not be constrained to lie wholly within, or wholly without, the scope of each checksum. In this case, one or more of the VCFs may be defined such that only a portion of the VCF falls within the scope of a checksum. As shown in FIG. 6B, to allow flexible positioning of VCFs, the mask for each checksum may include one bit corresponding to each byte of the VCFs. In the example of FIG. 6B, UDF1 and UDF2 are defined to have 4 bytes, UDF3 and UDF4 have 8 bytes, and UDF5 has only 2 bytes. Consequentially, each mask contains 28 bits—4 bits associated with each of UDF1 and UDF2, 8 bits associated with each of UDF3 and UDF4, 2 bits associated with UDF5, 1 bit associated with the length field, and 1 bit associated with the payload portion of the packet.

When the checksum masks contain one bit corresponding to each byte of each VCF, checksums may be calculated in accordance with the equation:

$${\overline{C S}}_{i} = P {S}_{i} + ( C {S}_{p} ) ( {m}_{i , p} ) + {\sum }_{j = 1}^{n} {\sum }_{k = 1}^{{l}_{j}} ( V C {F}_{j , k} ) ( {m}_{i , j , k} ) \qquad ( 2 )$$

where: sums are performed using one's complement addition of 16-bit segments;
CSᵢ=checksum i;
PSᵢ=the pre-sum associated with checksum i;
CSₚ=a checksum for the payload portion of the packet;
VCF_{j,k}=k'th byte of VCF j
m_{i,p}=the mask bit indicating if the payload checksum is within the scope of checksum i;
m_{i,j,k}=the mask bit indicating if the k'th byte of VCF j is within the scope of checksum i
lⱼ=the length, in bytes, of VCF j.

For convenience in calculating checksums, the length of the checksum masks may be standardized to accommodate the longest allowable VCF. For example, the masks in the table 600B may have contained 8 bits for each VCF, with the unused bits set to zero.

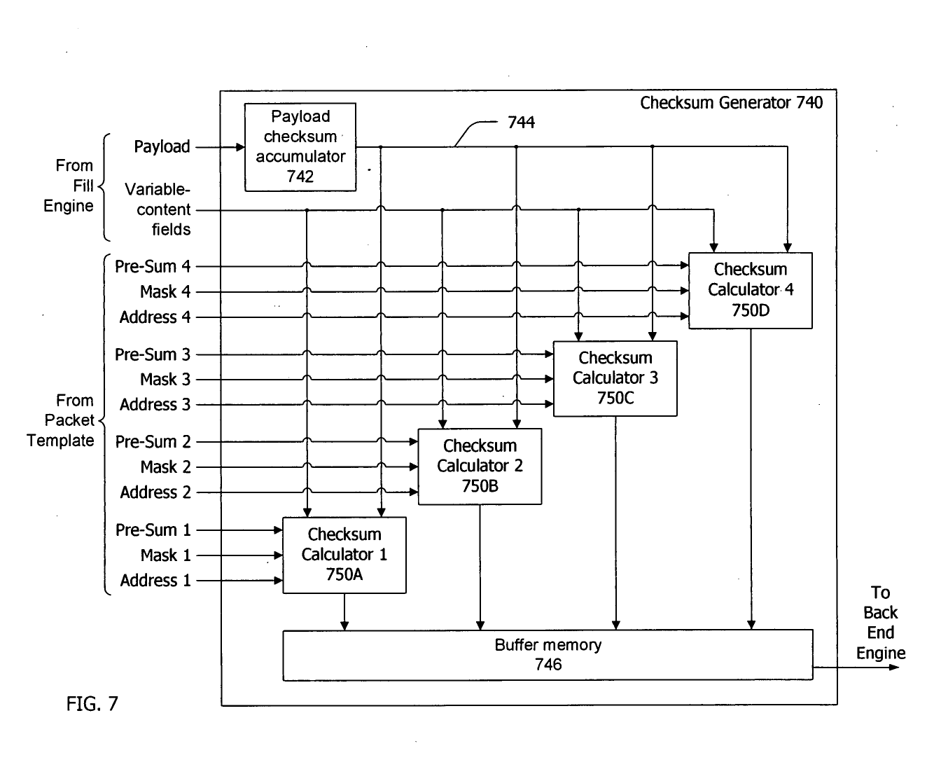

Referring now to FIG. 7, an exemplary checksum engine 740, which may be the checksum engine 340, may include a payload checksum accumulator 742 to calculate a payload checksum 744 for the payload portion of a packet, a buffer memory 746 to hold all or portions of the packet, and one or more checksum calculators 750A-750D. The exemplary checksum engine 740 shown in FIG. 7 includes four checksum calculators 750A, 750B, 750C, 750D. A checksum engine may have fewer or more than four checksum calculators.

Each of the checksum calculators 750A, 750B, 750C, 750D may receive a respective pre-sum, a respective mask, and a respective address, all of which may be included in a packet template used to generate the packet. Each of the checksum calculators 750A, 750B, 750C, 750D may also receive the content of one or more VCFs. Each of the checksum calculators 750A, 750B, 750C, 750D may include logic circuits to calculate a respective checksum based on the payload checksum, the VCFs, the respective pre-sum, and the respective mask. In this context, “logic circuits” means combinatorial logic circuits, sequential logic circuits, and combinations thereof. Each of the checksum calculators 750A, 750B, 750C, 750D may calculate the respective checksum in accordance with equation (1) or in accordance with equation (2). Each of the checksum calculators 750A, 750B, 750C, 750D may further include logic circuits to insert the calculated checksum into the packet at a position indicated by the respective address. The checksum may be inserted in the packet, for example, by writing the checksum into the buffer memory at a position indicated by the respective address. The respective address may indicate, for example, an offset from the start of the buffer where the checksum should be inserted.

Each of the checksum calculators 750A, 750B, 750C, 750D may calculate the respective checksum based, in part, on the content of VCFs within the packet. However, the checksum calculation does not depend on the positions that the VCFs occupy within the packet or the meanings of the VCFs within a communications protocol. Thus calculation of the checksums does not require parsing the packet to determine which fields should or should not be included in the checksum calculation.

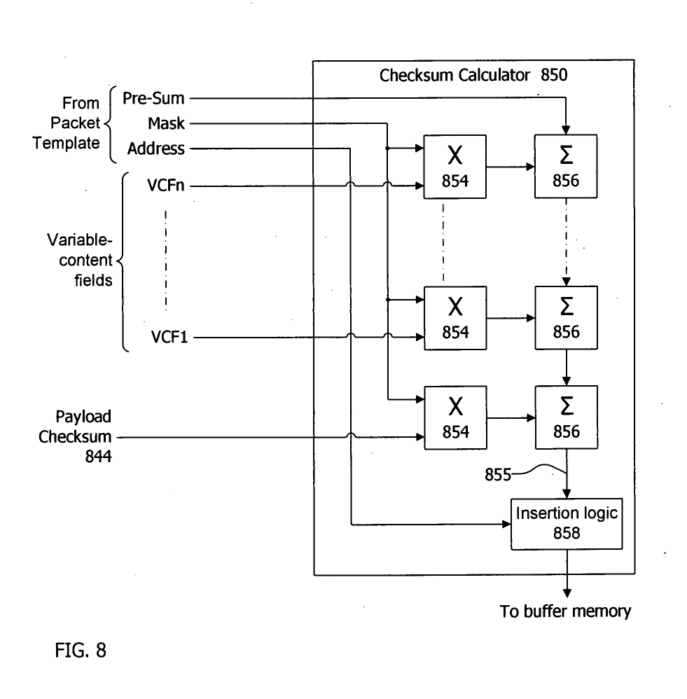

FIG. 8 is a block diagram of an exemplary checksum calculator 850, which may be suitable for use as the checksum calculators 750A-750D within the checksum engine 740. The checksum calculator 850 may receive a pre-sum, a mask, and an address, and may receive the content of a plurality of variable-content fields VCF1-VCFn and a payload checksum 844. The pre-sum, the mask, and the address, may be portions of a packet template, such as the template 335 retrieved from the template memory 332, used to form a packet. The content of the variable-content fields VCF1-VCFn may be received, for example, from a fill engine such as the fill engine 336. The payload checksum may be received from, for example, the payload checksum accumulator 742.

The checksum calculator 850 may multiply each of VCF1-VCFn and the payload checksum 844 by respective bits of the mask using a corresponding plurality of multipliers 854. The checksum calculator 850 may multiply each byte of VCF1-VCFn by a respective bit of the mask. Note that multiplying a field or a byte by a single mask bit simply requires forming the logic AND of each bit in the field and the mask bit. Thus the plurality of multipliers 854 may be implemented by an array of AND gates. The output of each multiplier 854 is the product of the respective VCF or payload checksum and the corresponding mask bit.

The output of each multiplier 854 may be applied to a plurality of one's complement adders 856. The one's complement adders 856 may be arranged, as shown in FIG. 8, in a cascade such that a sum output of each adder is passed as an input to a subsequent adder. Alternatively, the plurality of adders could be arranged as a tree. The plurality of one's complement adders 856 may add the pre-sum, the products of the VCFs and the corresponding mask bits, and the product of the payload checksum and the corresponding mask bit to form the checksum 855. Assuming that the propagation delay through each adder 856 is small compared to a clock period, the checksum calculator 850 may calculate the checksum 855 within a single clock cycle.

The checksum calculator may also include insertion logic 858 to insert the calculated checksum into the packet at a position indicated by the address included in the packet template used to form the packet.

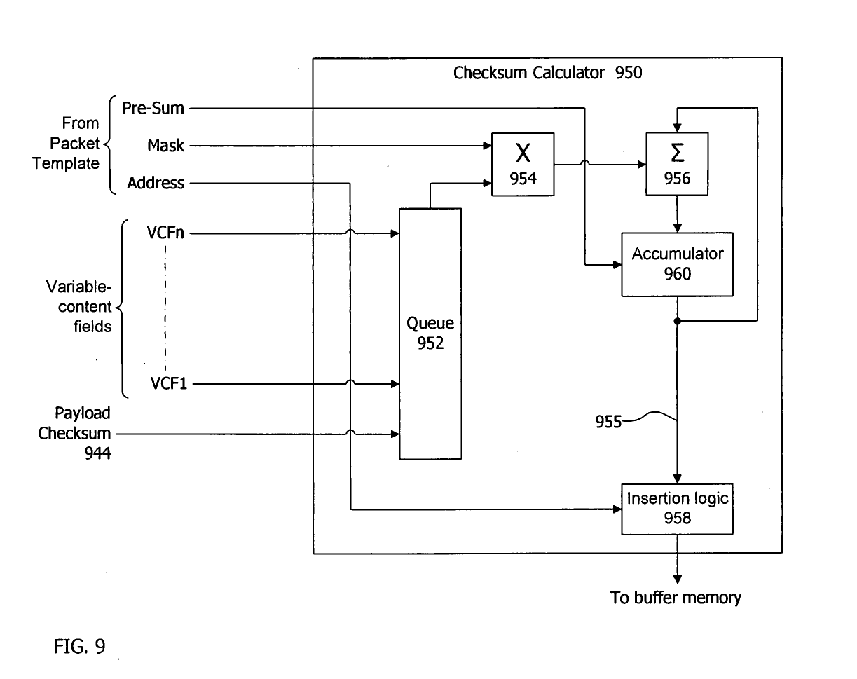

FIG. 9 is a block diagram of another exemplary checksum calculator 950, which may be suitable for use as the checksum calculators 750A-750D in the checksum engine 740. The checksum calculator 950 may receive a pre-sum, a mask, and an address, and may receive the content of a plurality of variable-content fields VCF1-VCFn and a payload checksum 944. The pre-sum, the mask, and the address may be portions of a packet template, such as the template 335 retrieved from the template memory 332, used to form a packet. The content of the variable-content fields VCF1-VCFn may be received, for example, from a fill engine such as the fill engine 336. The payload checksum may be received from, for example, the payload checksum accumulator 742.

To calculate a checksum defined by the packet template, the checksum calculator 950 may initially load the pre-sum into an accumulator 960 and temporarily store each of the variable-content fields VCF1-VCFn and the payload checksum 944 in a queue 952. The variable-content fields VCF1-VCFn and the payload checksum 944 may then be sequentially retrieved from the queue 952. Each retrieved field or byte may be multiplied by the respective bit of the mask using a multiplier 954 and added to the present value of the accumulator 960 using a one's complement adder 956. Note that multiplying a field or byte by a single mask bit simply requires forming the logic AND of each bit in the field and the mask bit. Thus the multiplier 954 may be implemented by an array of AND gates. The output of each multiplier 954 is the product of the respective variable-content field or payload checksum and the corresponding mask bit.

When the values of all of the VCFs and the payload checksum have been sequentially retrieved from the queue 952, multiplied by the appropriate mask bit or bits, and added to the accumulator 960, the final value in the accumulator 960 will be the defined checksum. Include insertion logic 958 may then insert the calculated checksum into the packet at a position indicated by the address included in the packet template used to form the packet.

The checksum calculator 850 of FIG. 8 and the checksum calculator 950 of FIG. 9 are examples of the use of combinatorial and sequential logic circuits to calculate a checksum in accordance with equation (1) or equation (2). Many other combinations and arrangements of logic circuits may also be used for the checksum calculator.

Description of Processes

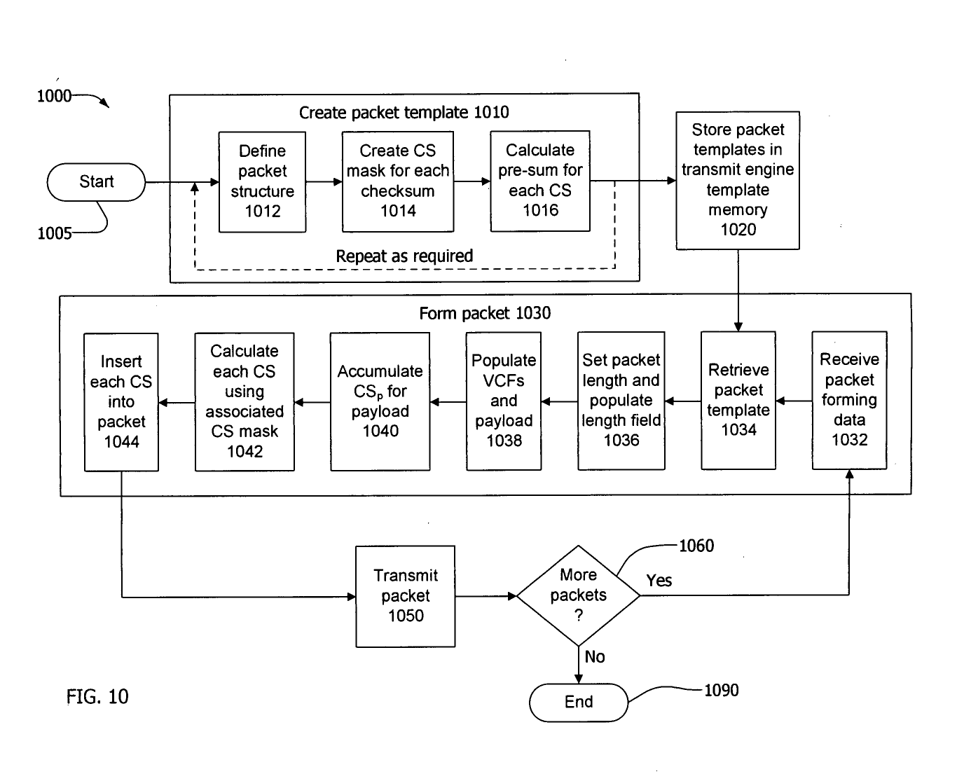

Referring now to FIG. 10, a process 1000 for generating traffic may start at 1005 and end at 1090. Portions of the process are inherently cyclic and the actions from 1030 to 1060 may be repeated cyclically by a traffic generator, such as the traffic generator 200, to form and transmit thousands or even millions of packets.

At 1010, at least one packet template defining the packets of an associated stream may be created. The structure of the packet may be defined at 1012. The defined structure may include the length and content of the packet header, the location and content of fixed-content data fields, the location and extent of any variable-content data fields, the scope and location or address of at least one checksum, and other information necessary to form the packet.

A checksum mask (CS) associated with each checksum may be created at 1014. Each checksum mask may include a single bit associated with each VCF indicating if the corresponding VCF is within the scope of the associated checksum. Each checksum mask may include a plurality of bits associated with each VCF, each bit indicating if a corresponding byte of the VCF is within the scope of the associated checksum. Each checksum mask may include a single bit indicating if the payload of the packet is within the scope of the associated checksum.

A pre-sum associated with each checksum may be calculated at 1016. Each pre-sum may be based on fixed-content fields within the scope of the associated checksum. Each pre-sum may be a checksum calculated over the fixed-content fields within the scope of the associated checksum.

The actions of 1010 may be repeated as needed to create a template for each packet stream of packet type that may be used by a test apparatus while running a test.

At 1020, all of the packet templates may be stored in a memory, such as the template memory 332, of a transmit engine, such as the transmit engine 330. The packet templates may be stored at 1020 at any time prior to forming packets based on the template. For example, one or more packet templates may be stored while setting up a test system for performing a test, or during the execution of a test when a new packet stream using the template is required.

A packet based on the packet template may be formed at 1030. To form a packet, packet forming data, such as the packet forming data 222 or 332, may be received at 1032 by a packet forming engine, such as the transmit engine 330. The packet forming data may be received from a scheduler such as the scheduler 220. The packet forming data may include data designating a packet template and other information required to form a packet.

The packet template designated in the packet forming data may be retrieved from a memory at 1034. The length of the packet may be set and a length field, if defined by the packet template, within the packet may be populated at 1036. For example, the length of the packet may be set at 1036 based on the packet forming data.

At 1038, VCFs and the payload portion of the packet may be filled. The VCFs and the payload portion of the packet may be filled in accordance with the packet template retrieved at 1034 and the packet forming data received at 1032.

At 1040, a payload checksum CSₚ for the payload portion of the packet may be accumulated. For example, the payload checksum may be accumulated by adding, using 1's complement addition, each successive 16-bit segment of the payload to an accumulator. The payload checksum may be accumulated while or after the payload content is filled at 1038.

At 1042, one or more checksums as defined in the packet forming data received at 1032. Each checksum may be calculated at 1042 based on the associated checksum mask from the packet template, the payload checksum accumulated at 1040, and the VCFs. Each checksum may be calculated in accordance with equation (1) as previously described.

At 1044, each checksum may be inserted into the packet at positions indicated by associated addresses included in the packet template. The packet may now be fully formed.

At 1050, the formed packet may be transmitted, for example through a network interface unit such as the network interface unit 280. At 1060, typically while the formed packet is being transmitted at 1050, a determination may be made if additional packets should be formed. The determination at 1060 may be made by comparing a total number of packets already transmitted to a predetermined required number of packets. The determination at 1060 may be made to form additional packet unless a command to stop transmitting packets has been received. If additional packets are required, the process 1000 may continue at 1032. The actions from 1030 to 1060 may be repeated cyclically until a very large number of packets have been formed and transmitted. When a determination is made at 1060 that no additional packets are required, the process 1000 may end at 1090.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be re-ordered, combined, or further refined to achieve the methods described herein. Steps shown to be sequential for ease of description may be performed, at least partially, concurrently. Acts, elements and features discussed only in connection with one embodiment are not intended to be excluded from a similar role in other embodiments.

For means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A traffic generator, comprising:
a scheduler to provide packet forming data defining a packet
a background engine to retrieve a packet template from a template memory, the packet template including a first checksum mask, a first pre-sum, and a first address
a fill engine to generate content for variable-content fields of the packet and for a payload portion of the packet in accordance with the packet forming data and the packet template
a checksum engine, comprising:
an accumulator that calculates a payload checksum for the payload portion of the packet
first logic circuits that compute a first checksum based on the first pre-sum, the first mask, and one or more of the payload checksum and the variable-content fields
insertion logic to insert the first checksum into the packet at a position indicated by the first address
a network interface to transmit the packet on a network.

2. The traffic generator of claim 1, wherein the first pre-sum is a value calculated as a checksum of fixed-content fields defined in the packet template.

3. The traffic generator of claim 2, wherein
the first logic circuits compute the first checksum by adding the first pre-sum, a product of the payload checksum and a corresponding bit of the first mask, and products of the one or more variable-content fields and corresponding bits of the first mask.

4. The traffic generator of claim 1, wherein
the template comprises n pre-sums, n masks, and n addresses, where n is an integer greater than 1
the checksum engine further comprising:
n checksum calculators to calculate n checksums, each checksum based on the respective pre-sum, the respective mask, and one or more of the payload checksum and the variable-content fields
insertion logic to insert each of the n checksums into the packet at respective positions indicated by the respective addresses.

5. The traffic generator of claim 4, wherein each of the n checksum calculators comprises hardware to calculate the respective checksum in accordance with the equation:
$${\overline{C S}}_{i} = P {S}_{i} + ( C {S}_{p} ) ( {m}_{i , p} ) + {\sum }_{j = 1}^{n} ( V C {F}_{j} ) ( {m}_{i , j} )$$
wherein: sums are performed using one's complement addition of 16-bit segments;
CSᵢ=checksum i, where i is an integer from 1 to n;
PSᵢ=the pre-sum associated with checksum i;
CSₚ=the checksum for the payload portion of the packet;
VCFⱼ=variable-content field j
m_{i,p}=a mask bit indicating if the payload checksum is within the scope of checksum i;
m_{i,j}=a mask bit indicating if variable-content field j is within the scope of checksum i.

6. The traffic generator of claim 4, wherein each of the n checksum calculators comprises hardware to calculate the respective checksum in accordance with the equation:
$${\overline{C S}}_{i} = P {S}_{i} + ( C {S}_{p} ) ( {m}_{i , p} ) + {\sum }_{j = 1}^{n} {\sum }_{k = 1}^{{l}_{j}} ( {VCF}_{j , k} ) ( {m}_{i , j , k} ) \qquad ( 2 )$$
wherein: sums are performed using one's complement addition of 16-bit segments;
CSᵢ=checksum i;
PSᵢ=the pre-sum associated with checksum i;
CSₚ=the checksum for the payload portion of the packet;
VCF_{j,k}=k'th byte of VCF j
m_{i,p}=a mask bit indicating if the payload checksum is within the scope of checksum i;
m_{i,j,k}=a mask bit indicating if the k'th byte of VCF j is within the scope of checksum i;
lⱼ=a length, in bytes, of VCF j.

7. The traffic generator of claim 4, wherein n is equal to four.

8. A checksum engine, comprising:
an accumulator that calculates a payload checksum for a payload portion of a packet
first logic circuits that compute a first checksum based on a first pre-sum, a first mask, and at least some of the payload checksum and variable-content fields of a header portion of the packet
insertion logic to insert the first checksum into the packet at a position indicated by a first address.

9. The checksum engine of claim 8, wherein the first pre-sum, the first mask, and the first address are portions of a packet template.

10. The checksum engine of claim 9, wherein the first pre-sum is a value calculated as a checksum of fixed-content fields defined in the packet template.

11. The checksum engine of claim 9, wherein
the first logic circuits compute the first checksum by adding the first pre-sum, a product of the payload checksum and a corresponding bit of the first mask, and products of the one or more variable-content fields and corresponding bits of the first mask.

12. The checksum engine of claim 9, wherein
the packet template comprises n pre-sums, n masks, and n addresses, where n is an integer greater than 1
the checksum engine further comprising:
n checksum calculators to calculate n checksums, each checksum based on the respective pre-sum, the respective mask, and at least some of the payload checksum and the variable-content fields
insertion logic to insert each of the n checksums into the packet at respective positions indicated by the respective addresses.

13. The checksum engine of claim 12, wherein each of the n checksum calculators comprises hardware to calculate the respective checksum in accordance with the equation:
$${\overline{C S}}_{i} = P {S}_{i} + ( C {S}_{p} ) ( {m}_{i , p} ) + {\sum }_{j = 1}^{n} ( V C {F}_{j} ) ( {m}_{i , j} )$$
where: sums are performed using one's complement addition of 16-bit segments;
CSᵢ=checksum i, where i is an integer from 1 to n;
PSᵢ=the pre-sum associated with checksum i;
CSₚ=the checksum for the payload portion of the packet;
VCFⱼ=variable-content header field j
m_{i,p}=a mask bit indicating if the payload checksum is within the scope of checksum i;
m_{i,j}=a mask bit indicating if variable-content field j is within the scope of checksum i.

14. The checksum engine of claim 12, wherein each of the n checksum calculators comprises hardware to calculate the respective checksum in accordance with the equation:
$${\overline{C S}}_{i} = P {S}_{i} + ( C {S}_{p} ) ( {m}_{i , p} ) + {\sum }_{j = 1}^{n} {\sum }_{k = 1}^{{l}_{j}} ( {VCF}_{j , k} ) ( {m}_{i , j , k} ) \qquad ( 2 )$$
wherein: sums are performed using one's complement addition of 16-bit segments;
CSᵢ=checksum i;
PSᵢ=the pre-sum associated with checksum i;
CSₚ=the checksum for the payload portion of the packet;
VCF_{j,k}=k'th byte of VCF j
m_{i,p}=a mask bit indicating if the payload checksum is within the scope of checksum i;
m_{i,j,k}=a mask bit indicating if the k'th byte of VCF j is within the scope of checksum i;
lⱼ=a length, in bytes, of VCF j.

15. The checksum engine of claim 12, wherein n is equal to four.

16. A computer readable storage medium having programming code stored thereon which, when used to program a field programmable gate array, will cause the field programmable gate array to be configured to include a checksum engine, the checksum engine comprising:
an accumulator that calculates a payload checksum for a payload portion of a packet
first logic circuits that compute a first checksum based on a first pre-sum, a first mask, and at least some of the payload checksum and variable-content fields of a header portion of the packet
insertion logic to insert the first checksum into the packet at a position indicated by a first address.

17. The computer readable storage medium of claim 16, wherein the first pre-sum, the first mask, and the first address are extracted from a packet template.

18. The computer readable storage medium of claim 17, wherein
the first logic circuits compute the first checksum by adding the first pre-sum, a product of the payload checksum and a corresponding bit of the first mask, and products of the one or more variable-content fields and corresponding bits of the first mask.

19. The computer readable storage medium of claim 18, wherein
the packet template comprises n pre-sums, n masks, and n addresses, where n is an integer greater than 1
the checksum engine further comprising:
n checksum calculators to calculate n checksums, each checksum based on the respective pre-sum, the respective mask, and at least some of the payload checksum and the variable-content fields
insertion logic to insert each of the n checksums into the packet at respective positions indicated by the respective addresses.

20. The computer readable storage medium of claim 19, wherein each of the n checksum calculators comprises hardware to calculate the respective checksum in accordance with the equation:
$${\overline{C S}}_{i} = P {S}_{i} + ( C {S}_{p} ) ( {m}_{i , p} ) + {\sum }_{j = 1}^{n} ( V C {F}_{j} ) ( {m}_{i , j} )$$
where: sums are performed using one's complement addition of 16-bit segments;
CSᵢ=checksum i, where i is an integer from 1 to n;
PSᵢ=the pre-sum associated with checksum i;
CSₚ=the checksum for the payload portion of the packet;
VCFⱼ=variable-content header field j
m_{i,p}=a mask bit indicating if the payload checksum is within the scope of checksum i;
m_{i,j}=a mask bit indicating if variable-content field j is within the scope of checksum i.

21. The computer readable storage medium of claim 19, wherein each of the n checksum calculators comprises hardware to calculate the respective checksum in accordance with the equation:
$${\overline{C S}}_{i} = P {S}_{i} + ( C {S}_{p} ) ( {m}_{i , p} ) + {\sum }_{j = 1}^{n} {\sum }_{k = 1}^{{l}_{j}} ( {VCF}_{j , k} ) ( {m}_{i , j , k} ) \qquad ( 2 )$$
wherein: sums are performed using one's complement addition of 16-bit segments;
CSᵢ=checksum i;
PSᵢ=the pre-sum associated with checksum i;
CSₚ=the checksum for the payload portion of the packet;
VCF_{j,k}=k'th byte of VCF j
m_{i,p}=a mask bit indicating if the payload checksum is within the scope of checksum i;
m_{i,j,k}=a mask bit indicating if the k'th byte of VCF j is within the scope of checksum i;
lⱼ=a length, in bytes, of VCF j.

22. The computer readable storage medium of claim 19, wherein n is equal to 4.

23. A method for generating a packet, comprising:
creating a template including a first pre-sum, a first mask, and a first address
generating content for one or more variable-content fields defined in the template
generating content for a payload portion of the packet
calculating a payload checksum from the content of the payload portion of the packet
calculating a first checksum based on the first pre-sum, the first mask, and at least some of the payload checksum and the contents of the variable-content fields
inserting the first checksum into the packet at a position indicated by the first address.

24. The method of claim 23, wherein calculating a first checksum comprises:
adding the first pre-sum, a product of the payload checksum and a corresponding bit of the first mask, and products of the one or more variable-content fields and corresponding bits of the first mask.

25. The method of claim 23, further comprising:
retrieving the template from a memory containing a plurality of packet templates.

26. The method of claim 23, further comprising:
calculating n checksums including the first checksum, where n is an integer greater than 1, based on n respective pre-sums, n respective masks and at least some of the payload checksum and contents of the variable-content fields,
inserting the n checksums into the packet at positions indicated by n respective addresses
wherein the n pre-sums, the n masks, and the n addresses are included in the template.

27. The method of claim 26, wherein at least one of the n checksums is based, in part, on the payload checksum.

28. The method of claim 26 wherein each of the n checksum is calculated in accordance with the equation:
$${\overline{C S}}_{i} = P {S}_{i} + ( C {S}_{p} ) ( {m}_{i , p} ) + {\sum }_{j = 1}^{n} ( V C {F}_{j} ) ( {m}_{i , j} )$$
where: sums are performed using one's complement addition of 16-bit segments;
CSᵢ=checksum i, where i is an integer from 1 to n;
PSᵢ=the pre-sum associated with checksum i;
CSₚ=the checksum for the payload portion of the packet;
VCFⱼ=variable-content header field j
m_{i,p}=a mask bit indicating if the payload checksum is within the scope of checksum i;
m_{i,j}=a mask bit indicating if variable-content field j is within the scope of checksum i.

29. The method of claim 26 wherein, wherein each of the n checksums is calculated in accordance with the equation:
$${\overline{C S}}_{i} = P {S}_{i} + ( C {S}_{p} ) ( {m}_{i , p} ) + {\sum }_{j = 1}^{n} {\sum }_{k = 1}^{{l}_{j}} ( {VCF}_{j , k} ) ( {m}_{i , j , k} ) \qquad ( 2 )$$
wherein: sums are performed using one's complement addition of 16-bit segments;
CSᵢ=checksum i;
PSᵢ=the pre-sum associated with checksum i;
CSₚ=the checksum for the payload portion of the packet;
VCF_{j,k}=k'th byte of VCF j
m_{i,p}=a mask bit indicating if the payload checksum is within the scope of checksum i;
m_{i,j,k}=a mask bit indicating if the k'th byte of VCF j is within the scope of checksum i;
lⱼ=a length, in bytes, of VCF j.
